(19) United States
(12) Patent Application Publication
(10) Pub. No.: US 2026/0273810 A1
(43) Pub. Date: Sep. 17, 2026

(54) RECYCLED POLYURETHANE FOAM COMPOSITION FOR AUTOMOTIVE INTERIOR MATERIALS AND POLYURETHANE FOAM MADE THEREFROM

(71) Applicants: Hyundai Motor Company, Seoul (KR); Kia Corporation, Seoul (KR); FOAM WORKS CO., LTD., Seoul (KR)

(72) Inventors: Won Jin Seo, Hwaseong-si (KR); Sung Hoon Lee, Hwaseong-si (KR); Ji Hoon Choi, Seoul (KR)

(73) Assignees: Hyundai Motor Company, Seoul (KR); Kia Corporation, Seoul (KR); FOAM WORKS CO., LTD., Seoul (KR)

(21) Appl. No.: 19/235,463

(22) Filed: Jun. 11, 2025

(30) Foreign Application Priority Data
Mar. 13, 2025 (KR) 10-2025-0032550

(51) Int. Cl. B29C 44/20; B29L 31/30; C08J 9/00

(52) U.S. Cl. CPC B29C 44/20; C08J 9/00; B29L 2031/30; C08J 2375/04

(57) ABSTRACT

The present disclosure relates to a recycled polyurethane foam composition for automotive interior materials and polyurethane foam made therefrom. The recycled polyurethane foam composition and polyurethane foam reduces carbon emissions by establishing a waste resource circulation system through recycling waste polyurethane foam, and exhibits physical properties equivalent to those of virgin polyurethane foam, making it commercially viable.

### CROSS-REFERENCE TO RELATED APPLICATION

This present application claims the benefit of priority to Korean Patent Application No. 10-2025-0032550, filed on Mar. 13, 2025, in the Korean Intellectual Property Office, the entire disclosure of which is incorporated herein by reference in its entirety.

### FIELD

The present disclosure relates to a recycled polyurethane foam composition for automotive interior materials and polyurethane foam made therefrom.

### BACKGROUND

In recent years, the global imperative to reduce carbon emissions has amplified the focus on recycling industrial waste, positioning it as a critical component of sustainability initiatives. Notably, polyurethane foam, a material extensively utilized across diverse sectors such as automotive interiors, furniture, and construction, has come under scrutiny due to its significant environmental repercussions during both production and disposal. Consequently, the advancement of effective recycling technologies for polyurethane foam is essential to mitigate its ecological footprint and promote a circular economy that minimizes waste and maximizes resource efficiency.

The manufacturing processes of polyurethane foam generates a substantial volume of scrap material during both production and processing stages, which is conventionally managed through disposal methods such as landfilling or incineration. These practices not only exacerbate environmental pollution, but also contribute significantly to carbon dioxide emissions, highlighting a critical need for more sustainable waste management solutions within the polyurethane foam industry. Addressing this issue is imperative for minimizing the ecological footprint associated with polyurethane foam production, thereby fostering a more environmentally responsible approach to manufacturing and resource utilization.

In response to the challenges posed by waste generated from polyurethane foam manufacturing, there has been a growing interest in developing technologies aimed at producing recycled polyurethane foam from scrap material. This heightened focus underscores the necessity for innovative recycling processes that not only facilitate the repurposing of foam waste, but also ensure that the physical properties of the recycled product closely replicate those of virgin polyurethane foam. Establishing such standards is essential for fostering the commercial viability of recycled polyurethane foam, thereby contributing to more sustainable manufacturing practices and enabling a circular economy within the industry.

The matters described in this Background section are only for enhancement of understanding of the background of the disclosure, and should not be taken as acknowledgement that they correspond to references already known to those skilled in the art.

### SUMMARY

The following summary presents a simplified summary of features disclosed herein. The summary is not an extensive overview and is not intended to identify key or critical elements.

The present disclosure is directed to providing a recycled polyurethane foam composition and polyurethane foam made therefrom.

The present disclosure is further directed to providing a recycled polyurethane foam that exhibits physical properties equivalent to those of virgin polyurethane foam, making it commercially viable.

The present disclosure is further directed to providing a recycled polyurethane foam composition and polyurethane foam that may be applied to green technology fields, such as recycling technology for automotive interior materials.

In embodiments, the present disclosure provides a recycled polyurethane foam composition comprising 30 to 50 parts by weight of an isocyanate and 1 to 10 parts by weight of an additive based on 100 parts by weight of polyol, wherein the polyol may include a base polyol, a recycled polyol, and an LF polyol.

The polyol according to one embodiment may include the base polyol, the recycled polyol, and the LF polyol in a weight ratio of 1:(0.2 to 1):(0.05 to 0.5).

The recycled polyol according to one embodiment may be derived from waste polyurethane foam.

The isocyanate according to one embodiment may include one or more selected from the group consisting of toluene diisocyanate-80 (TDI-80), toluene diisocyanate-65 (TDI-65), monomeric MDI, carbodiimide, and polymeric MDI.

The additive according to one embodiment may include one or more selected from the group consisting of water, a catalyst, and a surfactant.

In embodiments, the present disclosure provides a recycled polyurethane foam manufactured by foaming and molding the recycled polyurethane foam composition by a continuous slab stock method.

In embodiments, the present disclosure provides an automotive seat manufactured by adhering the recycled polyurethane foam to an automotive seat fabric using a method selected from the group consisting of hot melt adhesion, flame lamination, and PU adhesion.

The recycled polyurethane foam composition and polyurethane foam made therefrom according to embodiments of the present disclosure may reduce carbon emissions by establishing a waste resource circulation system through recycling waste polyurethane foam.

Furthermore, the recycled polyurethane foam according to embodiments of the present disclosure may exhibit physical properties equivalent to those of virgin polyurethane foam, making it commercially viable.

### BRIEF DESCRIPTION OF THE DRAWINGS

The foregoing and other aspects, as well as the following detailed description of the embodiments, should be better understood when read in conjunction with the accompanying drawings. However, the present disclosure is not intended to be limited to the details shown in the drawings, and various modifications and structural changes may be made therein without departing from the spirit of the present disclosure and within the scope and range of equivalents of the claims. Like reference numbers and designations in the various drawings indicate like elements.

FIG. 1 is a flowchart of a manufacturing process for recycled polyurethane foam according to one embodiment of the present disclosure.

### DETAILED DESCRIPTION

Hereinafter, the present disclosure will be described in more detail. However, the following embodiments are provided merely as references for describing the present disclosure in detail, and the present disclosure is not limited thereto and may be implemented in various forms

Unless otherwise defined, all technical and scientific terms used herein have the same meaning as commonly understood by those skilled in the art to which the present disclosure pertains.

The terms used herein are intended merely to describe particular embodiments effectively and are not intended to limit the present disclosure.

Singular forms “a,” “an,” and “the” used in the specification and the appended claims are intended to include plural referents unless the context clearly dictates otherwise.

The units used in this specification, unless otherwise stated, are based on weight. For instance, the units such as “%” or “ratio” refer to weight percent (wt. %) or weight ratio, respectively. Unless otherwise defined, weight percent (wt. %) refers to the proportion of a specific component within the total composition, expressed as a percentage by weight.

When a portion is described as “including” or “comprising” a certain component, it means that, unless specifically stated to the contrary, the inclusion of other components is not excluded but rather that additional components may also be included.

In addition, numerical ranges used in this specification may include all values between the lower and upper limits, all values incrementally derived logically within shape and breadth of the defined ranges, all double-limited values, and all possible combinations of upper and lower limits of differently limited numerical ranges. Unless specifically defined in the specification of the present disclosure, values outside the defined numerical ranges that may occur due to experimental error or rounding off of values are also included within the defined numerical ranges.

The term “waste polyurethane foam” used in this specification may refer to polyurethane foam scrap generated during the polyurethane foam manufacturing process.

The following provides a more detailed description of the present disclosure.

Embodiments of the present disclosure may provide a recycled polyurethane foam composition comprising a polyol, an isocyanate, and an additive, wherein the polyol comprises a base polyol, a recycled polyol, and an LF polyol.

In one embodiment, the recycled polyurethane foam composition may comprise 30 to 50 parts by weight of an isocyanate and 1 to 10 parts by weight of an additive based on 100 parts by weight of the polyol, and specifically, may comprise 35 to 50 parts by weight of an isocyanate and 3 to 6 parts by weight of an additive based on 100 parts by weight of the polyol. When satisfying the above range, improved physical properties for the recycled polyurethane foam may secured while maximizing recycled content.

In one embodiment, the recycled polyol may be derived from waste polyurethane foam. Specifically, the recycled polyol may be derived by processing waste polyurethane foam using a one-shot method, specifically by depolymerizing the waste polyurethane foam with a depolymerization catalyst and glycol, and controlling the process to prevent layer separation by substituting the resulting amine components.

In one embodiment, the recycled content of the recycled polyol may have a lower limit of at least 30 wt %, at least 35 wt %, at least 40 wt %, or at least 45 wt %, and an upper limit of 50 wt % or less.

In one embodiment, the polyol may comprise the base polyol, the recycled polyol, and the LF polyol in a weight ratio of 1:(0.2 to 1):(0.05 to 0.5), specifically 1:(0.25 to 0.9):(0.06 to 0.4). When satisfying the above range, improved physical properties for the recycled polyurethane foam may be secured.

In one embodiment, the base polyol may be a material obtained by reacting an initiator such as a multifunctional alcohol or aromatic amine having at least one hydroxyl group (—OH) in the molecule and having three or more hydroxyl groups or amine groups (—NH₂), with propylene oxide (PO) or ethylene oxide (EO) under appropriate conditions. The base polyol may be broadly classified as polyether polyols and polyester polyols. These can be used by adjusting the initiator and molecular weight of the product according to the intended use.

Polyether polyols were developed for the manufacturing of polyurethane foam, and are manufactured by adding propylene oxide (PO) or ethylene oxide (EO) to an initiator having two or more active hydrogens (—OH, NH₂), and have advantages of improved hydrolysis resistance and low-temperature characteristics compared to propylene glycol (PPG), tetramethylene glycol (PTMEG), ethylene glycol (PEG), and polyester.

Polyester polyols may be manufactured by dehydration condensation reaction of a dibasic acid (adipic acid) with glycol or triol, and the appearance and physical properties of the resulting polyester polyol may vary depending on the type of acid, polyol, and molecular weight used.

The base polyol of the present disclosure may use polyether polyols for polyurethane foam, such as polyether polyol obtained by adding alkylene oxide such as ethylene oxide, propylene oxide, or the like, to polyhydric alcohols such as ethylene glycol, diethylene glycol, propylene glycol, dipropylene glycol, butylene glycol, neopentyl glycol, glycerin, pentaerythritol, trimethylolpropane, sorbitol, sucrose, or the like.

In one embodiment, the LF polyol (low functionality polyol) may be a material obtained by reacting an initiator such as an alcohol or aromatic amine having at least one hydroxyl group in the molecule and having two or fewer hydroxyl groups or amine groups, with propylene oxide or ethylene oxide under appropriate conditions.

The recycled polyol may use a polymer with a number average molecular weight of 2,000 to 8,000, which is a complex emulsion-type polyol formed by decomposing waste polyurethane foam at a temperature range of 120 to 200° C. by low molecular weight glycol or cyclic carbonate ester after processing the waste polyurethane foam to a size of 0.5 cm to 5 cm. By using a recycled polyol, it may be possible to reduce carbon dioxide emissions by not using an alkylene oxide such as ethylene oxide, propylene oxide, or the like, which are used to manufacture base polyol.

In one embodiment, the isocyanate may comprise one or more selected from the group consisting of toluene diisocyanate-80 (TDI-80), toluene diisocyanate-65 (TDI-65), monomeric MDI, carbodiimide, and polymeric MDI, but is not limited thereto as long as it can achieve the objectives of the present disclosure.

In one embodiment, the additive may comprise one or more selected from the group consisting of water, a catalyst, and a surfactant.

In one embodiment, the catalyst may be used alone or in combination with amine catalysts and metal catalysts (organic metal compound catalysts) for polyurethane foam. Examples of the amine catalysts may include monoamine compounds, diamine compounds, triamine compounds, polyamine compounds, cyclic amine compounds, alcohol amine compounds, ether amine compounds, and the like, and these may be one type or a combination of two or more types. Examples of the metal catalysts may include organic tin compounds, organic bismuth compounds, organic lead compounds, organic zinc compounds, and the like, and these may be one type or a combination of two or more types.

In one embodiment, the surfactant may be a non-ionic surfactant such as polydimethylsiloxane or polyoxyalkylene, but is not limited thereto.

In one embodiment, the additive may comprise the water, the catalyst, and the surfactant in a weight ratio of 1:(0.01 to 0.5):(0.001 to 0.5), specifically 1:(0.02 to 0.4):(0.002 to 0.5).

In addition, embodiments of the present disclosure may provide a recycled polyurethane foam manufactured by foaming and molding the recycled polyurethane foam composition by a continuous slab stock method.

Furthermore, embodiments of the present disclosure may provide an automotive seat manufactured by adhering the recycled polyurethane foam to an automotive seat fabric using a method selected from the group consisting of hot melt adhesion, flame lamination, and PU adhesion.

Hereinafter, various examples of the present disclosure and comparative examples will be described. However, the following examples are merely various examples of the present disclosure, and the present disclosure is not intended to be limited thereto.

### Example 1

A polyol was prepared by mixing 55 parts by weight of base polyol, 30 parts by weight of recycled polyol, and 15 parts by weight of LF polyol.

As the isocyanate, Toluene diisocyanate-80 was prepared at 38 parts by weight.

An additive was prepared by mixing 2.3 parts by weight of water, 0.1 parts by weight of catalyst, and 1.5 parts by weight of surfactant.

After adding the polyol, isocyanate, and additive to a mixer and stirring, the stirred mixture was added to a conveyor belt equipped with a continuous release film and freely foamed by a continuous slab stock method to manufacture a cured recycled polyurethane foam.

### Example 2 and Comparative Examples 1 to 4

Polyurethane foam was manufactured in the same manner as Example 1, except that each component was included in the amount described in Table 1 below.

TABLE 1

| | Base | Recycled | LF | | | | |
|---|---|---|---|---|---|---|---|
| | Polyol | Polyol | Polyol | Water | Catalyst | Surfactant | Isocyanate |
| Example 1 | 55 | 30 | 15 | 2.3 | 0.1 | 1.5 | 38 |
| Comparative Example 1 | 85 | 0 | 15 | 2.3 | 0.1 | 1.5 | 37 |
| Example 2 | 53 | 30 | 17 | 3 | 0.15 | 1.5 | 42 |
| Comparative Example 2 | 83 | 0 | 17 | 3 | 0.15 | 1.5 | 41 |
| Comparative Example 3 | 80 | 0 | 20 | 3.7 | 0.19 | 1.5 | 46 |
| Comparative Example 4 | 75 | 5 | 20 | 3.6 | 0.19 | 1.5 | 46 |

Base Polyol: Polyether polyol with a number average molecular weight of 2800-4000 Mn and a functionality of 3
Recycled Polyol: Recycled polyether polyol with a number average molecular weight of 2800-4000 Mn and a functionality of 3
LF Polyol: Polyester-based polyol used in flame lamination process
Catalyst: Amine-based catalyst
Surfactant: Polydimethylsiloxane
Isocyanate: TDI-80
Unit: Parts by weight

### Experimental Example (Physical Property Evaluation and Recycled Content Calculation)

The physical properties of the polyurethane foam of the above examples and comparative examples were evaluated and the recycled content was calculated through the following measurement methods, and the results are shown in Table 2 below.

### Measurement and Calculation Methods

Density: Measured according to JIS K 6401.
Hardness: Measured according to KS M 6672.
Permanent Compression Set: Measured according to ASTM D 3574-95.
Recycled Content: (Recycled raw material weight)/(Total raw material weight−Gas loss)×100 wt %

Gas loss may be omitted if calculation is difficult.

TABLE 2

| | | | Permanent | Recycled |
|---|---|---|---|---|
| | Density | Hardness | Compression | Content |
| | (kg/m³) | (kgf/314 cm²) | Set (%) | (wt %) |
| Example 1 | 40 | 30 | 2.4 | 6.3 |
| Comparative | 40 | 35 | 2.3 | 0 |
| Example 1 | | | | |
| Example 2 | 32 | 11 | 4.3 | 6.1 |
| Comparative | 32 | 12 | 4 | 0 |
| Example 2 | | | | |
| Comparative | 26 | 15 | 4.8 | 0 |
| Example 3 | | | | |
| Comparative | 26 | 15 | 24 | 0.9 |
| Example 4 | | | | |

As can be seen in Table 2, the recycled polyurethane foam manufactured from the recycled polyurethane foam composition according to Examples 1 and 2 of the present disclosure exhibits high recycled content by replacing part of the base polyol with recycled polyol, while showing hardness equivalent to the comparative examples that did not use recycled polyol. The permanent compression set is also less than 5%, confirming that it can be sufficiently used for automotive interior materials.

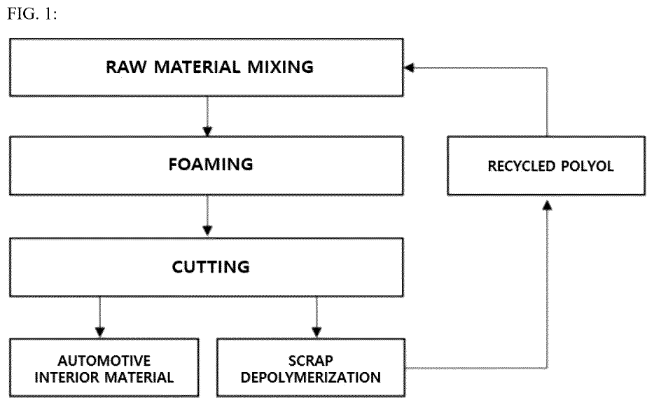

Furthermore, through the present disclosure, it was confirmed that a waste resource circulation system (FIG. 1) may be established by producing recycled polyurethane foam using scrap generated during the polyurethane foam production process, and by using scrap generated from this process.

While the present disclosure has been described above in relation to its embodiments, it is to be understood that these are only examples and do not limit the present disclosure, and those skilled in the art in the field to which the present disclosure belongs will understand that various modifications and applications not described above are possible without departing from the essential characteristics of the present disclosure. For example, each component specifically described in the embodiments can be modified, and implemented as modified. Further, differences related to these modifications and applications are to be understood as being included in the scope of the present disclosure defined in the appended claims.

What is claimed is:

1. A recycled polyurethane foam composition, comprising 30 to 50 parts by weight of an isocyanate and 1 to 10 parts by weight of an additive based on 100 parts by weight of a polyol, wherein the polyol comprises a base polyol, a recycled polyol, and an LF polyol.

2. The recycled polyurethane foam composition of claim 1, wherein the polyol comprises the base polyol, the recycled polyol, and the LF polyol in a weight ratio of 1:(0.2 to 1):(0.05 to 0.5).

3. The recycled polyurethane foam composition of claim 1, wherein the recycled polyol is derived from waste polyurethane foam.

4. The recycled polyurethane foam composition of claim 3, wherein the recycled polyol has a recycled content of 30 to 50 wt %.

5. The recycled polyurethane foam composition of claim 1, wherein the isocyanate comprises one or more of toluene diisocyanate-80 (TDI-80), toluene diisocyanate-65 (TDI-65), monomeric MDI, carbodiimide, polymeric MDI, and any combination thereof.

6. The recycled polyurethane foam composition of claim 1, wherein the additive comprises one or more of water, a catalyst, a surfactant, and any combination thereof.

7. The recycled polyurethane foam composition of claim 6, wherein the additive comprises the water, the catalyst, and the surfactant in a weight ratio of 1:(0.01 to 0.5):(0.001 to 0.5).

8. A recycled polyurethane foam manufactured by foaming and molding the recycled polyurethane foam composition of claim 1 by a continuous slab stock method.

9. An automotive seat manufactured by adhering the recycled polyurethane foam of claim 8 to an automotive seat fabric using a method selected from the group consisting of hot melt adhesion, flame lamination, and PU adhesion.
